(19) United States
(12) Patent Application Publication
(10) Pub. No.: US 2004/0073834 A1
(43) Pub. Date: Apr. 15, 2004

(54) System and method for expanding the management redundancy of computer systems

(76) Inventors: Kaamel M. Kermaani, Cupertino, CA (US); Ramani Krishnamurthy, Fremont, CA (US); Balkar S. Sidhu, San Jose, CA (US)

Correspondence Address: BRIAN M BERLINER, ESQ, O'MELVENY & MYERS, LLP, 400 SOUTH HOPE STREET, LOS ANGELES, CA, 90071-2899, US

(21) Appl. No.: 10/268,387

(22) Filed: Oct. 10, 2002

(51) Int. Cl. H04L 1/22

(52) U.S. Cl. 714/13

(57) ABSTRACT

An interconnect system connects two or more drawers (or servers) of a redundant computer system, wherein each drawer contains independent nodes of the computer system. Each of the drawer comprises a Drawer Management Card (DMC) designed for managing the nodes of that drawer. The present invention provides for methods and apparatus to redundantly manage the two or more drawers. In one embodiment, each drawer is provided with at least two DMCs by interconnecting the management channels of the two or more drawers (e.g., using a cable mechanism). Thus, by interconnecting the management channels of the two or more drawers, the drawers can be managed in a redundant manner. That is, if a failure occurs on one DMC in the interconnected drawers, another DMC in the interconnected drawers can take over and manage the drawers. In addition, the present invention provides such management redundancy without significantly increasing the cost and real estate of the drawers.

### BACKGROUND OF THE INVENTION

1. Field of the Invention

The present invention relates to computer systems and the like, more particularly, to a system and method for interconnecting computer servers to achieve redundancy in system management.

2. Description of Related Art

Computers on a computing system can be categorized as two types: servers and clients. Those computers that provide services (e.g., Web Services) to other computers are servers (like JAVA servers or Mainframe servers); the computers that connect to and utilize those services are clients.

Redundant systems are appropriate for various computing applications. As used herein, redundancy refers to duplication of electronic elements to provide alternative functional channels in case of failure, and a redundant node or element is one that provides this redundancy. A redundant system is a system containing redundant nodes or elements for primary system functions.

In a redundant computing system, two or more computers are utilized to perform a processing function in parallel. If one computer of the system fails, the other computer of the systems are capable of handling the processing function, so that the system as a whole can continue to operate. Redundant computing systems have been designed for many different applications, using many different architectures. In general, as computer capabilities and standards evolve and change, so do the optimal architectures for redundant systems.

For example, a standard may permit or require that the connectivity architecture for a redundant system be Ethernet-based. One such standard is the PCI Industrial Computer Manufacturers Group (PICMG) PSB Standard No. 2.16. In an Ethernet-based system, redundant nodes of the system communicate using an Ethernet protocol. Such systems may be particularly appropriate for redundant server applications.

A server (herein called “drawers”) can be designed with a variety of implementations/architectures that are either defined within existing standards (for example the PCI Industrial Computer Manufactures Group or PICMG standards), or can be customized architectures. The drawer includes a drawer management card (DMC) for managing operation of the drawer. The DMC manages, for example, temperature, voltage, fans, power supplies, etc. of the drawer. A redundant drawer management system comprises two or more DMCs connected by a suitable interconnect.

It is desired, therefore, to provide a redundant drawer management system suitable for use with an Ethernet-based connectivity architecture, and with other connectivity architectures. It is further desired to provide a system and method for interconnecting DMCs of the redundant system. The system and method should support operation of the drawers in a redundant mode. That is, if one DMC of the system experiences a failure, the other DMC or DMCs of the system should be able to assume the managing function that has been lost by the failure via an interconnection. At the same time, the system and method should provide that if the interconnection fails (i.e., if there is a “connection failure”), it is immediately detected by each affected DMC. The connection failure may then be reported, and the affected DMCs may operate in a non-redundant mode until the connection failure can be repaired. In addition, since providing a redundant drawer management system may increase the cost and real estate of the drawer system, it is further desired to provide methods and apparatus for providing such management redundancy without greatly increasing the cost and real estate of the drawer systems.

### SUMMARY OF THE INVENTION

The present invention provides interconnect methods and apparatus suitable for providing management redundancy for compactPCI systems. The interconnect methods and apparatus may be used with Ethernet-based systems, although it is not thereby limited. A connection architecture is provided that permits redundant management of two or more drawers (or servers). In addition to providing the connections needed for redundant management of the two or more drawers, the interconnect methods and apparatus also do not significantly increase the cost and real estate of the drawers.

In one embodiment, a compact peripheral component interconnect (compactPCI) computer architecture includes a plurality of compactPCI systems. Each of the compactPCI system includes a plurality of nodes. The nodes include a computational service provider, a fan, a system control board, and/or a power supply. Each of the compactPCI system also includes a drawer management card (DMC). Each DMC has a plurality of local communication links that provides management interfaces for the plurality of nodes. A bridge assembly is used to communicate with the compactPCI systems. The bride assembly includes a cable that is compatible with any one of the local communication links. The cable interconnects the compactPCI systems together. The cable is connected with the compactPCI systems through the DMC on each the compactPCI systems. Thus, if one of the DMC in one of the compactPCI systems fails to provide management of the nodes, another DMC can assume the management of the nodes.

In a second embodiment, a compact peripheral component interconnect (compactPCI) computer architecture includes first and second compactPCI drawer systems. The first drawer system includes a first plurality of nodes and a first drawer management card (DMC). The first DMC includes a first plurality of communication links that provides management interfaces for the first plurality of nodes. The second drawer system includes a second plurality of nodes and a second DMC. The second DMC includes a second plurality of communication links that provides management interfaces for the second plurality of nodes. A cable compatible with any one of the plurality of communication links is connected with the first and second DMCs. Thus, management operations provided from any one of the DMCs can manage any one of the plurality of nodes. In addition, upon a failure of the first DMC, the second DMC can assume a management operation of the first DMC.

A third embodiment of the present invention involves an interconnect method which includes the following steps. A first drawer management card (DMC) is provided to a first compactPCI drawer system. A first plurality of nodes is provided on the first compactPCI drawer system. A second DMC is provided to a second compactPCI drawer system. The second drawer system is also provided with a second plurality of nodes. A cable is used to connect the second DMC with the first DMC. The first DMC is selected to be in an active state. The second DMC is selected to be in a standby state. Upon the selection of the DMC states, the first DMC actively manages the first and second plurality of nodes. The second DMC periodically checks a condition on the first DMC. The second DMC is switched to be in an active state if the checked condition matches a predetermined condition. Upon the switching of the state of the second DMC, the second DMC begins to manage the first and second plurality of nodes while the first DMC stops managing the nodes.

A more complete understanding of the system and method for interconnecting nodes of a redundant computer system will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is an exploded perspective view of a compactPCI chassis system according to an embodiment of the invention;

FIG. 2 shows the form factors that are defined for the compactPCI node card;

FIG. 3 is a front view of a backplane having eight slots with five connectors each;

FIG. 4(a) shows a front view of another compactPCI backplane;

FIG. 4(b) shows a back view of the backplane of FIG. 4(a);

FIG. 5 shows a side view of the backplane of FIGS. 4(a) and 4(b);

FIG. 6 is a block diagram of a redundant system according to the invention;

FIG. 7 is a block diagram of another redundant system according to the invention;

FIG. 8 is a block diagram showing an exemplary interconnect system for a redundant computer system according to an embodiment of the invention;

FIG. 9 is a block diagram showing another exemplary interconnect system according to an embodiment of the invention;

FIGS. 10(a) and 10(b) are a flow diagram showing exemplary steps of a method according to the invention.

### DETAILED DESCRIPTION OF THE PREFERRED EMBODIMENT

The present invention provides a method and apparatus for providing a redundant drawer (or server) management system, that overcomes the limitations of the prior art. The system and method are applicable to a server or a plurality of servers, each having at least one Ethernet link port and at least one server or drawer management card (DMC), wherein at least two of the DMCs are interconnected. A server may be defined as a computer that may be programmed and/or used to perform different computing functions, including but not limited to, routing traffic and data over a wide area network, such as the Internet; managing storage and retrieval of data, data processing, and so forth. In the context of the present invention, the servers may be referred to as drawers, and individually, as a drawer.

Embodiments of the present invention can be implemented with a Compact Peripheral Component Interconnect (compactPCI). CompactPCI is a high performance industrial bus based on the standard PCI electrical specification in rugged 3U or 6U Eurocard packaging (e.g., PICMG compactPCI standards). CompactPCI is intended for application in telecommunications, computer telephony, real-time machine control, industrial automation, real-time data acquisition, instrumentation, military systems or any other application requiring high speed computing, modular and robust packaging design, and long-term manufacturer support. Because of its high speed and bandwidth, the compactPCI bus is particularly well suited for many high-speed data communication applications such as for server applications.

Compared to a standard desktop PCI, a server (or drawer) having compactPCI supports twice as many PCI slots (typically 8 versus 4) and offers an ideal packaging scheme for industrial applications. A compactPCI drawer system includes compactPCI node cards that are designed for front loading and removal from a card chassis. The compactPCI node cards include processing unit(s) and/or location(s) for the drawer and are firmly held in position by their connector, card guides on both sides, and a faceplate that solidly screws into the card rack. The compactPCI node cards are mounted vertically allowing for natural or forced air convection for cooling. Also, the pin-and-socket connector of the compactPCI node card is significantly more reliable and has better shock and vibration characteristics than the card edge connector of the standard PCI node cards.

The compactPCI drawer also includes at lease one drawer management card (DMC) for managing the drawer. The DMC manages, for example, the temperature, voltage, fans, power supplies, etc. of the drawer. Typically, a DMC is provided with signals and/or alarms in case of a failure of the managing function of the DMC to, for example, prevent overheating of the drawer. However, because of the desire to operate without interruption on the failure of a DMC, in one embodiment of the present invention, the DMC works with one or more companion DMCs (i.e., with one or more additional DMCs) in a redundant arrangement. This embodiment allows the drawer to operate uninterrupted in the event of the failure or inoperativeness of one of the DMCs in a cooperative group of DMCs.

In a first embodiment of the present invention, a drawer management system that interconnects a first DMC and a second DMC within a drawer is provided. The drawer contains a plurality of computing nodes (e.g., node cards) and may be compliant to PICMG 2.16 standards. The nodes within the drawer are managed through a bus, such as an Intelligent Platform Management Bus (IPMB). The other field replaceble units (FRUs) or hardware components in the drawer—such as fans, power supplies, etc. may be managed using a separate bus, such as an Inter Integrated Circuit bus (l2C). The first and second DMCs are interconnected with each other within a chassis of the drawer. The two DMCs are also interconnected with the management channels (e.g., buses) of the drawer. Redundant management for the drawer is provided by the second DMC because both the first DMC and the second DMC can deliver management services to the drawer via the interconnection. As a result, the drawer is provided with management services from the second DMC in the event of a management failure in the first DMC.

In a second embodiment of the present invention, during power up, a first DMC and a second DMC on a drawer may determine whether the DMC's are interconnected (or not). The DMCs then decide each of their roles (i.e., determining which DMC should be in an active state and which DMC should be in a standby state). Thus, by interconnecting (e.g., the IPMBs and I2Cs of) the two DMC's, both of the DMC's are able to manage nodes on a drawer, and the drawer is allowed to operate uninterrupted in the event of a failure or inoperativeness of one of the DMCs.

In a third embodiment of the present invention, a redundant drawer management system includes at least two servers (or drawers) connected together to interconnect management channels from one drawer to the other drawer and to interconnect DMCs of the two drawers to allow management redundancy. Each of the drawers contains a plurality of computing nodes (e.g., node cards) and may be compliant to PICMG 2.16 standards. These nodes are managed through a bus, such as an IPMB. In addition, the other FRUs in each of the interconnected drawers may be managed by at least one of the interconnected DMCs using a separate bus, such as a I2C.

In a fourth embodiment of the present invention, a drawer (e.g., a first drawer) has a DMC. The DMC may manage at least one other drawer (e.g., a second drawer) by interconnecting the (first and second) drawers' IPMBs and I2Cs (e.g., by a physical cable compatible with I2C and IPMB signals). The at least one other drawer (e.g., the second drawer) also has a DMC (e.g., a second DMC). During power up, the DMCs on each of the interconnected drawers (or the cooperative group of drawers) will identify, whether the drawers are interconnected or not. The DMCs then decide each of their roles (i.e., determining which DMC should be in an active state and which DMC should be in a standby state). Thus, by interconnecting the IPMBs and I2Cs across the drawers, a DMC is able to remotely manage nodes on another drawer or drawers, and the drawers are allowed to operate uninterrupted in the event of a failure or inoperativeness of one of the DMCs of a cooperative (or interconnected) group of drawers.

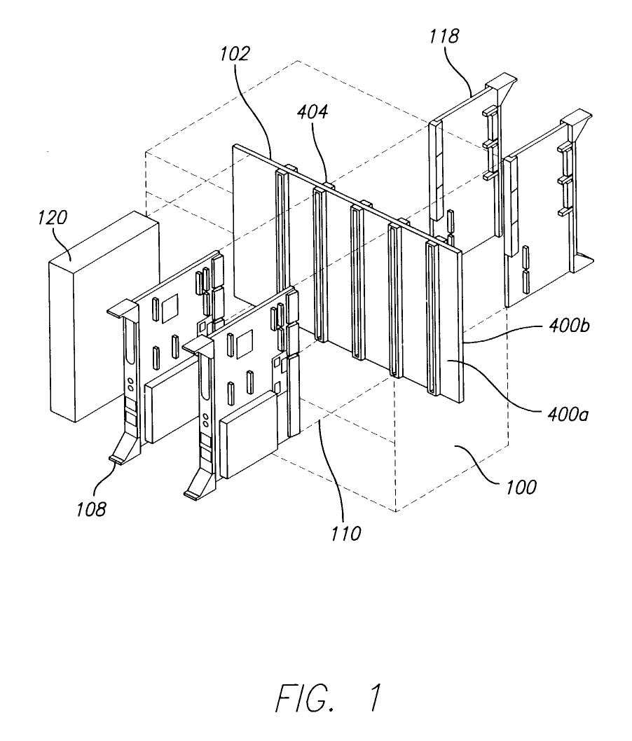

Referring to FIG. 1, there is shown an exploded perspective view of a compactPCI drawer system as envisioned in an embodiment of the present invention. The drawer system comprises a chassis 100. The chassis 100 includes a compactPCI backplane 102. The backplane 102 is located within chassis 100 and compactPCI node cards can only be inserted from the front of the chassis 100. The front side 400a of the backplane 102 has slots provided with connectors 404. A corresponding transition card 118 is coupled to the node card 108 via backplane 102. The backplane 102 contains corresponding slots and connectors (not shown) on its backside 400b to mate with transition card 118. In the chassis system 100 that is shown, a node card 108 may be inserted into appropriate slots and mated with the connectors 404. For proper insertion of the node card 108 into the slot, card guide(s) 110 are provided. This drawer system provides front removable node cards and unobstructed cooling across the entire set of node cards. The system is also connected to a power supply (not shown) that supplies power to the system.

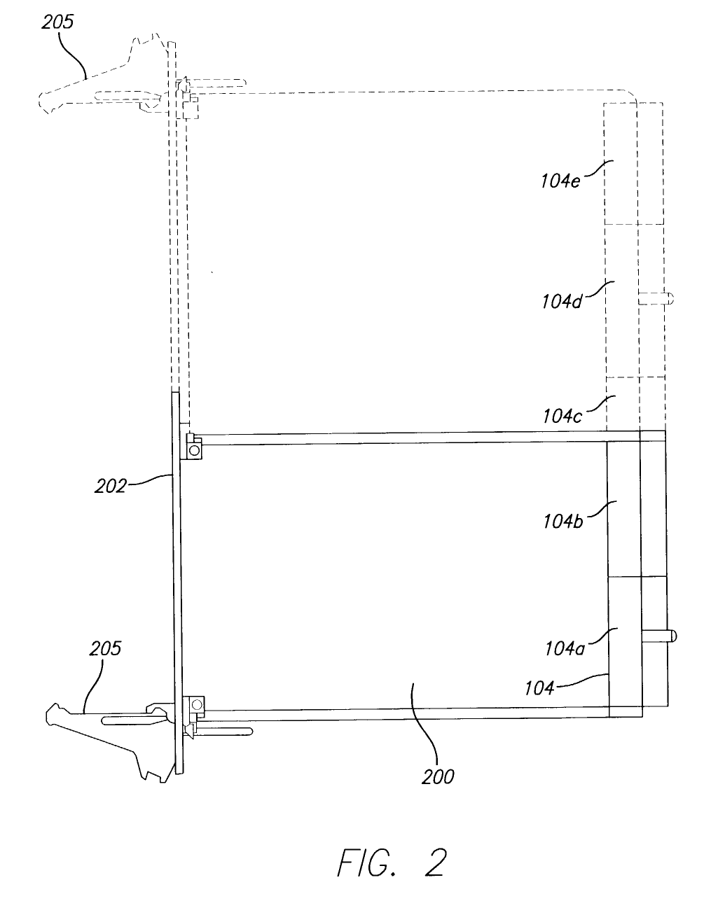

Referring to FIG. 2, there are shown the form factors defined for the compactPCI node card, which is based on the PICMG compactPCI industry standard (e.g., the standard in the PICMG 2.0 compactPCI specification). As shown in FIG. 2, the node card 200 has a front panel assembly 202 that includes ejector/injector handles 205. The front panel assembly 202 is consistent with PICMG compactPCI packaging and is compliant with IEEE 1101.1 or IEEE 1101.10. The ejector/injector handles should also be compliant with IEEE 1101.1. Two ejector/injector handles 205 are used for the 6U node cards in the present invention. The connectors 104a-104e of the node card 200 are numbered starting from the bottom connector 104a, and the 6U front card size is defined, as described below. The dimensions of the 3U form factor are approximately 160.00 mm by approximately 100.00 mm, and the dimensions of the 6U form factor are approximately 160.00 mm by approximately 233.35 mm. The 3U form factor includes two 2 mm connectors 104a-104b and is the minimum, as it accommodates the full 64 bit compactPCI bus. Specifically, the 104a connectors are reserved to carry the signals required to support the 32-bit PCI bus; hence, no other signals may be carried in any of the pins of this connector. Optionally, the 104a connectors may have a reserved key area that can be provided with a connector “key,” which is a pluggable plastic piece that comes in different shapes and sizes so that the add-on card can only mate with an appropriately keyed slot. The 104b connectors are defined to facilitate 64-bit transfers or for rear panel I/O in the 3U form factor. The 104c-104e connectors are available for 6U systems as also shown in FIG. 2. The 6U form factor includes the two connectors 104a-104b of the 3U form factor, and three additional 2 mm connectors 104c-104e. In other words, the 3U form factor includes connectors 104a-104b, and the 6U form factor includes connectors 104a-104e. The three additional connectors 104c-104e of the 6U form factor can be used for secondary buses (i.e., Signal Computing System Architecture (SCSA) or MultiVendor Integration Protocol (MVIP) telephony buses), bridges to other buses (i.e., Virtual Machine Environment (VME) or Small Computer System Interface (SCSI)), or for user specific applications. Note that the compactPCI specification defines the locations for all the connectors 104a-104e, but only the signal-pin assignments for the compactPCI bus portion 104a and 104b are defined. The remaining connectors are the subjects of additional specification efforts or can be user defined for specific applications, as described above.

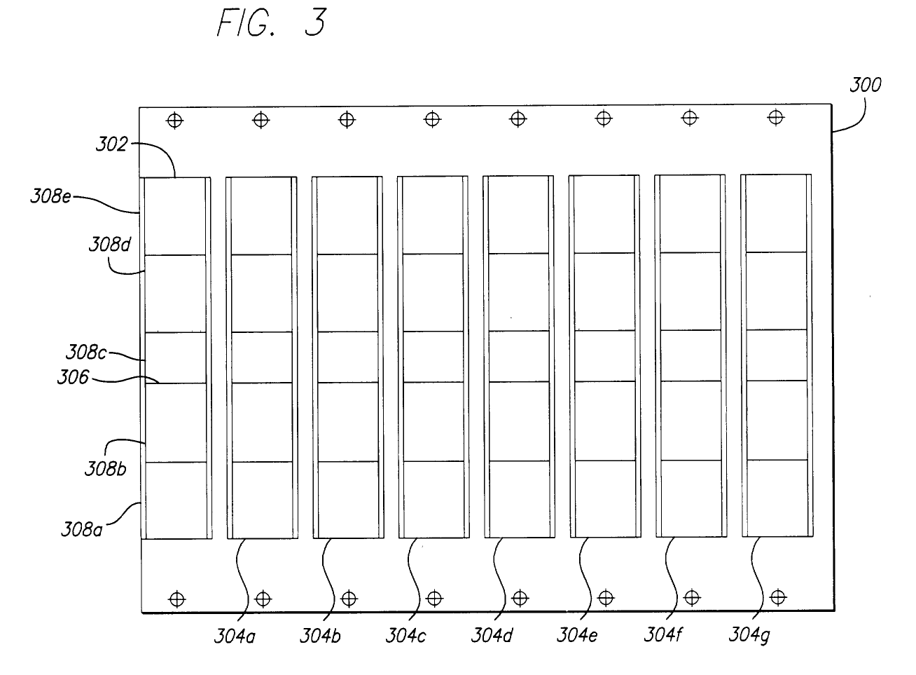

Referring to FIG. 3, there is shown a front view of a 6U backplane having eight slots. A compactPCI drawer system includes one or more compactPCI bus segments, where each bus segment typically includes up to eight compactPCI card slots. Each compactPCI bus segment includes at least one system slot 302 and up to seven peripheral slots 304a-304g. The compactPCI node card for the system slot 302 provides arbitration, clock distribution, and reset functions for the compactPCI peripheral node cards on the bus segment. The peripheral slots 304a-304g may contain simple cards, intelligent slaves and/or PCI bus masters.

The connectors 308a-308e have connector-pins 306 that project in a direction perpendicular to the backplane 300, and are designed to mate with the front side “active” node cards (“front cards”), and “pass-through” its relevant interconnect signals to mate with the rear side “passive” input/output (I/O) card(s) (“rear transition cards”). In other words, in the compactPCI system, the connector-pins 306 allow the interconnected signals to pass-through from the node cards to the rear transition cards.

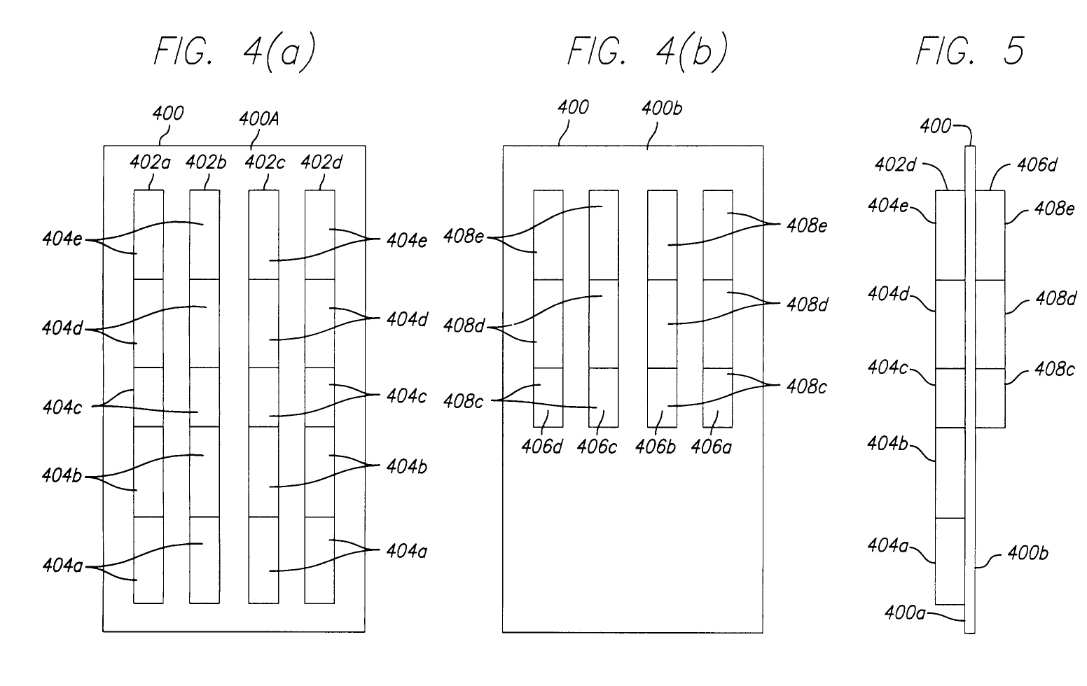

Referring to FIGS. 4(a) and 4(b), there are shown respectively a front and back view of a compactPCI backplane in another 6U form factor embodiment. In FIG. 4(a), four slots 402a-402g are provided on the front side 400a of the backplane 400. In FIG. 4(b), four slots 406a-406g are provided on the back side 400b of the backplane 400. Note that in both FIGS. 4(a) and 4(b) only four slots are shown instead of eight slots as in FIG. 3. Further, it is important to note that each of the slots 402a-402d on the front side 400a has five connectors 404a-404e while each of the slots 406a-406d on the back side 400b has only four connectors 408b-408e. This is because, as in the 3U form factor of the conventional compactPCI drawer system, the 404a connectors are provided for 32 bit PCI and connector keying. Thus, they do not have I/O connectors to their rear. Accordingly, the node cards that are inserted in the front side slots 402a-402d only transmit signals to the rear transition cards that are inserted in the back side slots 406a-406d through front side connectors 404b-404e.

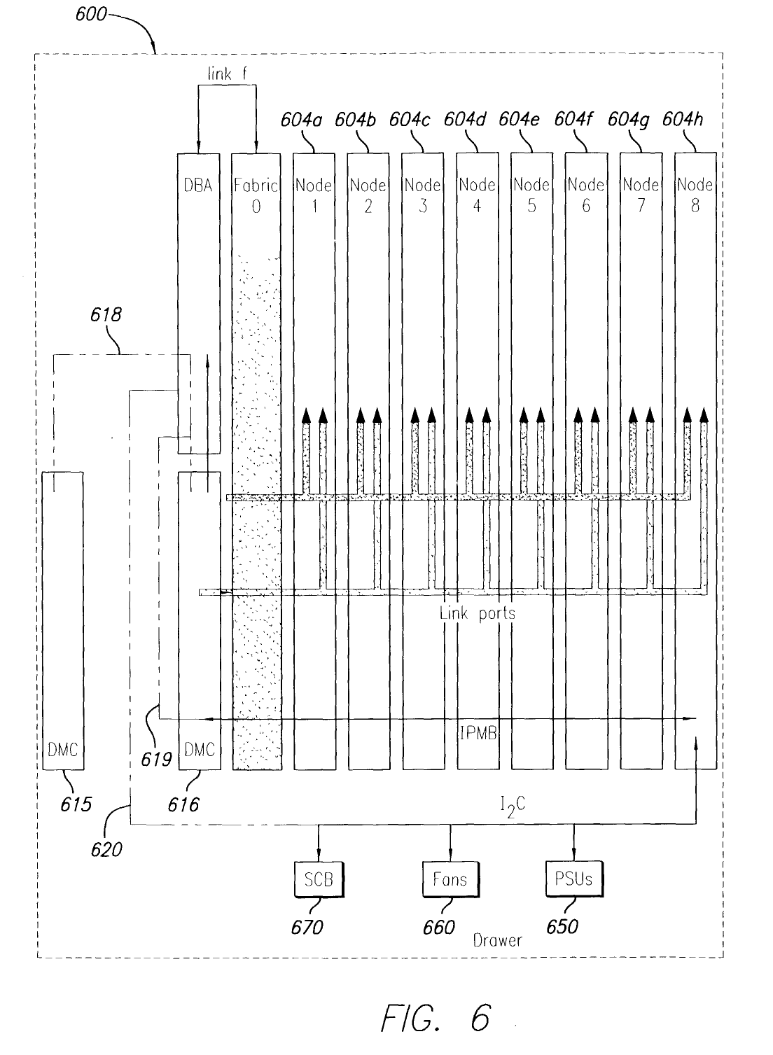

Referring to FIG. 5, there is shown a side view of the backplane of FIGS. 4(a) and 4(b). As shown in FIG. 5, slot 402d on the front side 400a and slot 406d on the back side 400b are arranged to be substantially aligned so as to be back to back. Further, slot 402c on the front side 400a and slot 406c on the backside 400b are arranged to be substantially aligned, and so on. Accordingly, the front side connectors 404b-404e are arranged back-to-back with the back side connectors 408b-408e. Note that the front side connector 404a does not have a corresponding back side connector. It is important to note that the system slot 402a is adapted to receive the node card having a central processing unit (CPU); the signals from the system slot 402a are then transmitted to corresponding connector-pins of the peripheral slots 402b-402d. Thus, the compactPCI system can have expanded I/O functionality by adding peripheral front cards in the peripheral slots 402b-402d.

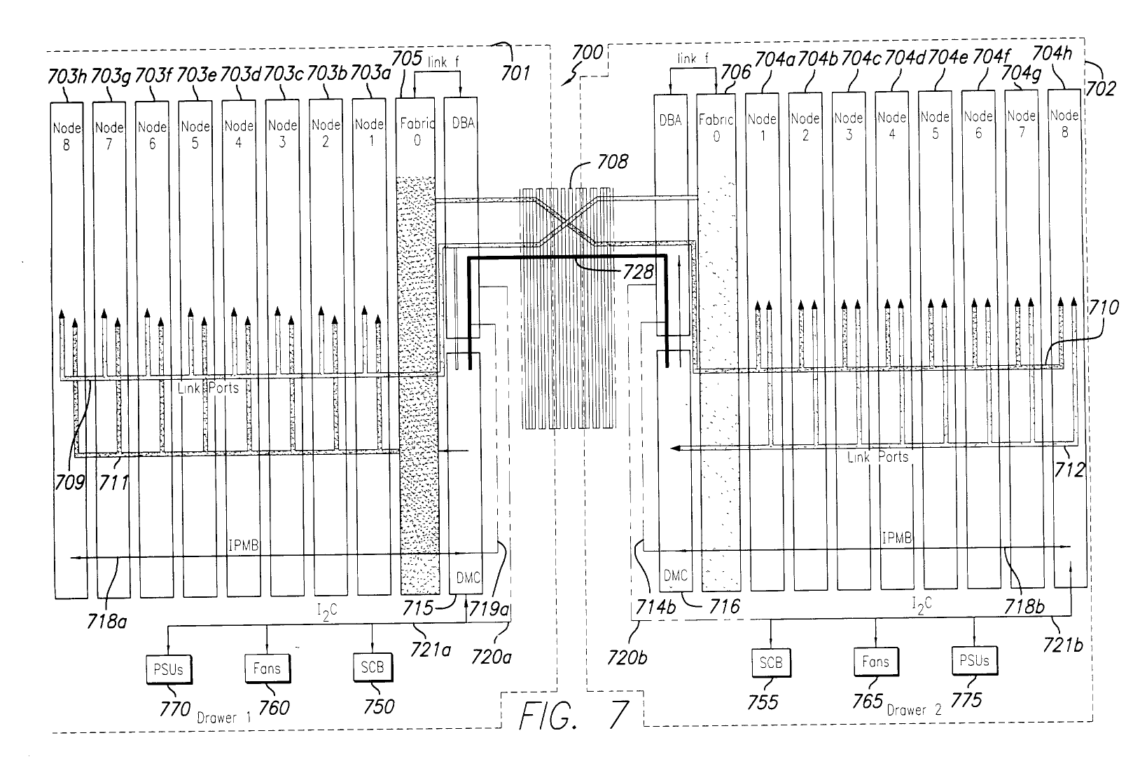

As previously stated, redundant management is provided to a drawer system, such as a compactPCI drawer system described above, in order to safeguard the system against management failures. In one embodiment of the present invention, redundant management is provided by connecting two DMCs to a drawer system as shown in FIG. 6. The system comprises a drawer 600. The drawer 600 comprises node cards 604a-g, power supplies 650, fans 660, a system control board (SCB) 670, and light emitting diode (LED) panels (not shown). Any number of node cards may be provided; even though, eight node cards are show in this example. Each node card may provide two or more Ethernet (or link) ports. The node cards may be compliant with an industry standard, for example, PICMG standard No. 2.16. The drawer further comprises a fabric card 605 for providing Ethernet switching functions for the node cards.

The drawer 600 also comprises a drawer management card (DMC) 616 and a secondary DMC 615 for providing redundant management of the drawer 600. The DMC 616 manages operation of the drawer 600, such as managing all the node cards 604a-h through an IPMB 619 and other FRUs (such as power supplies 650, fans 660, and LED panel) through a I2C 620. If the DMC 616 becomes disabled and/or inactive (e.g., in a standby state), the secondary DMC 615 can manage operation of the drawer 600. A suitable link 618 connects the secondary DMC 615 with the DMC 616 to permit redundant operation of the DMCs 615, 616. Within the drawer 600, the DMCs, switch card, and node cards may be connected by a midplane board (not shown).

In one embodiment, if a DMC becomes inoperative, redundant operation of system 600 is lost, but system 600 may still be capable of functioning in a non-redundant mode. In another embodiment of the invention, if any of the DMCs becomes inoperative, a system operator may be alerted to the loss of redundancy through activation of a visible or audible indicator on a system front panel, or by any other suitable method.

In addition, it is desirable to provide a mechanism to determine which of the DMCs will function as the active DMC and which of the DMCs will function as the standby DMC. Accordingly, in one embodiment, the active DMC is predetermined and is the DMC which has control of the drawer's management and the standby DMC heartbeats (or periodically checks) with the active DMC to determine whether the active DMC is healthy (i.e., in good operation mode) or not. In another embodiment, when the system is power on, both DMCs will be in the standby mode. The active role is decided on how the DMCs are hardwired and/or is based on a software. Further features, objects, embodiments, functions, and/or mechanisms of selecting active/standby DMC are described in greater detail below.

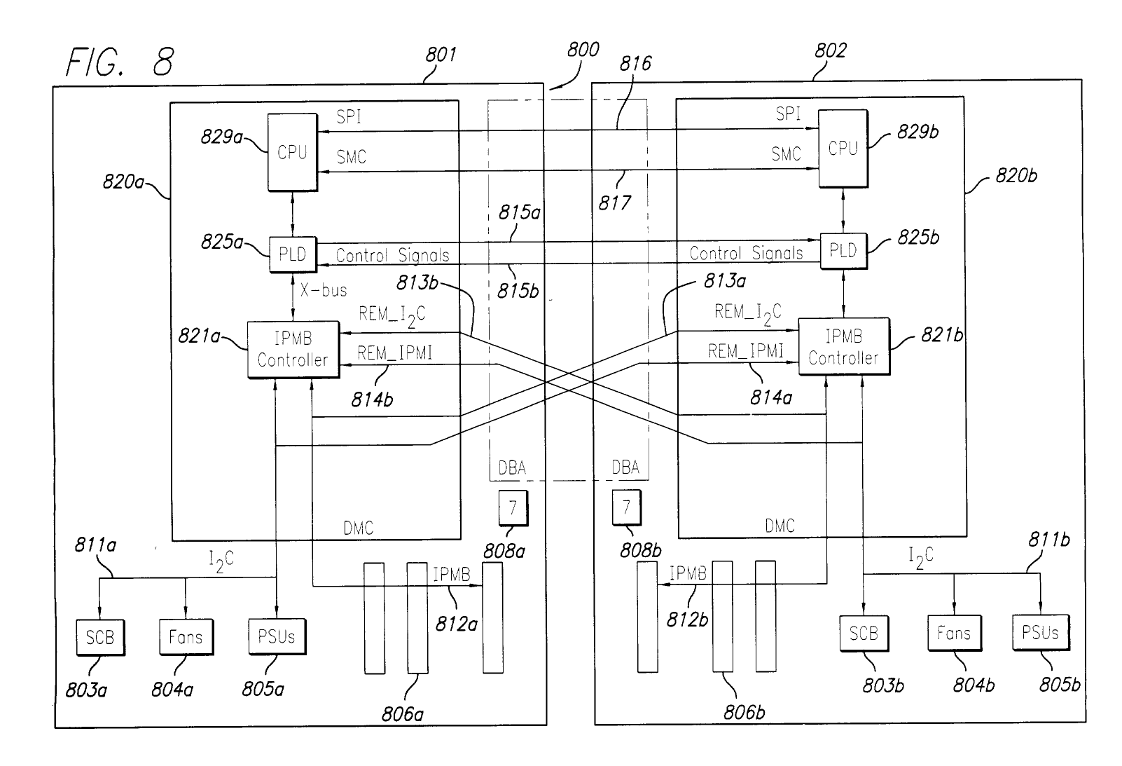

It should be understood that the management system described above may also be used to provided redundant management to a number of drawers. Referring to FIG. 7, an example of a redundant management system for multiple drawers is provided according to an embodiment of the invention. As illustrated, the system comprises drawers 701 and 702. While two drawers are shown, it should be apparent that any plural number of drawers may be used in accordance with the teachings of the present invention. Each drawer comprises a plurality of node cards 703a-h and 704a-h, power supplies 770 and 775, fans 760 and 765, SCB 770 and 775, and LED panels (not shown). Any number of node cards may be provided; even though, eight node cards are show in this example. Each node card may provide two or more Ethernet (or link) ports. The node cards may be compliant with an industry standard, for example, PICMG standard No. 2.16. Each drawer further comprises fabric cards 705, 706, respectively, for providing Ethernet switching functions for the node cards. Fabric card 705 controls switching for link ports 709, 711 of drawer 701. Similarly, in drawer 702, fabric card 706 controls switching for link ports 710, 712.

Each drawer 701, 702 also comprises a drawer management card (DMC) 715, 716, respectively, for managing operation of the drawers. DMC 715 manages operation of drawer 701, such as managing all the node cards 703a-g through IPMB 719a and other FRUs through I2C 720a. In addition, DMC 715 may manage operation of drawer 702, if drawers 701, 702 are connected and DMC 716 becomes disabled and/or inactive (e.g., in a standby state). In like manner, DMC 716 manages operation of drawer 102 (through 719b and 720b), and may manage drawer 701 if DMC 715 becomes disabled and/or inactive. A drawer bridge assembly (DBA) 708 includes a suitable link 718, such as a cable, to permit redundant operation of DMCs 715, 716. In one embodiment, the suitable link 718 comprises a physical cable that is connected with the I2Cs 720a-b and the IPMBs 719a-b. The cable is compatible with the signals on the I2Cs 720a-b and the IPMBs 719a-b. In addition, since I2Cs and IPMBs are slow speed buses and have a capacitive loading maximum of 400 pf, an embodiment of the present invention provides a cabling mechanism that overcomes the capacitive loading limitations of the I2Cs and IPMBs. In another embodiment, a plurality of buffering and connecting mechanisms (not shown) for each of the drawers (e.g., a plurality of capacitors, resistors, grounds, etc.) are used with the cable to overcome the capacitive loading limitations of the I2Cs and IPMBs.

Thus, according to the foregoing, redundant management of at least two drawers is achieved whenever DBA 708 connects DMCs 715, 716. For example, if DMC 715 fails, DMC 716 may manage the operation on any of the node cards 703a-h, via the DBA 708. Similarly, in the event of a failure of DMC 716, DMC 715 may manage the operation on any of the node cards 704a-h, via DBA 708

If DBA 708 becomes disconnected, redundant operation of system 700 is lost, but system 700 may still be capable of functioning in a non-redundant mode. In a non-redundant mode, drawers 701, 702 operate independently to perform the functions of system 700. It is desirable, therefore, to provide a mechanism by which the DMC of each drawer is alerted when DBA 708 becomes inoperative. For example, in an embodiment of the invention, DBA 708 comprises a cable 728 having an end attached to each drawer of the system. If any of the cable ends becomes disconnected, the DMCs 715,716 of both affected drawers 701, 702 should be interrupted and a non-redundant redundant mode operation should be initiated within each drawer 701, 702. That is, if an end of DBA 708 attached to drawer 701 becomes disconnected, both DMC 715 and DMC 716 should be alerted. A system operator may also be alerted to the loss of redundancy, through activation of a visible or audible indicator on a system front panel, or by any other suitable method.

It is also desirable to provide a mechanism to determine which of the DMC will function as the active DMC and which of the DMC will function as the standby DMC when DBA 808 is operative. Accordingly, in one embodiment, the active DMC is predetermined and is the DMC which has control of the management of both drawers and the standby DMC heartbeats (or periodically checks) with the active DMC to determine whether the active DMC is health (i.e., in good operation mode) or not. In another embodiment, when the system power is on, both DMCs will be in the standby mode. The active role is based on how the DMCs are hardwired and/or is based on a software.

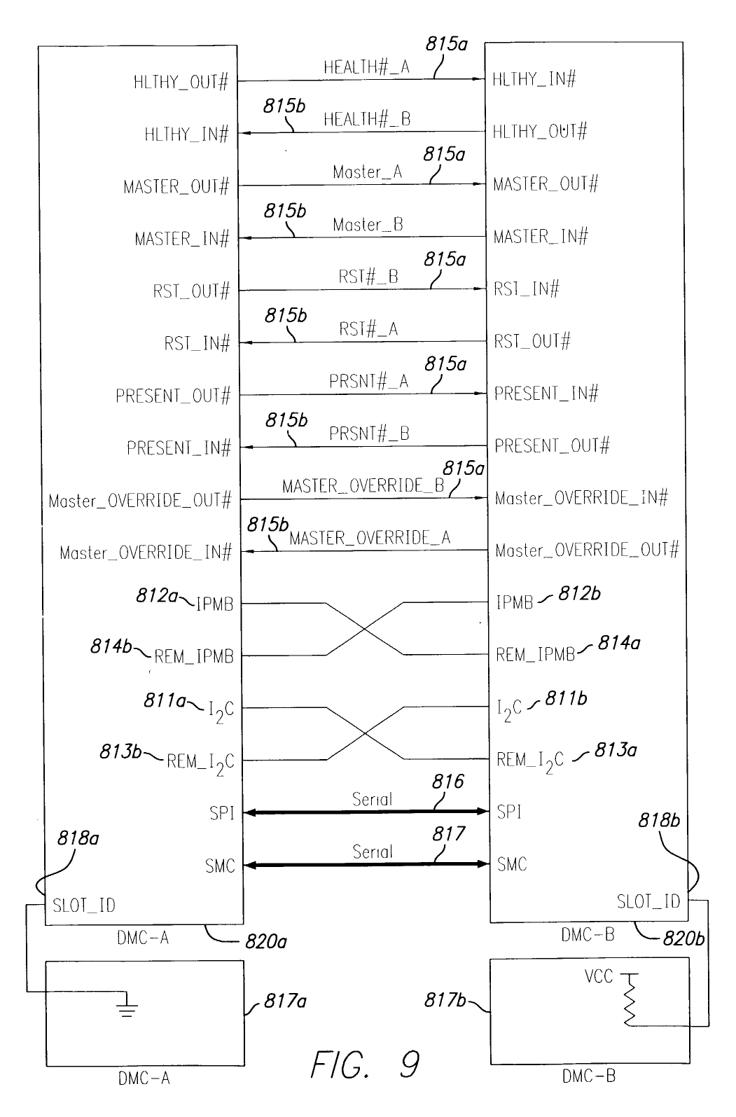

FIG. 8 shows an exemplary redundant system 800 comprising a drawer 801 connected to a drawer 802 via a DBA 808 according to an embodiment of the present invention. Each of the drawers 801, 802 includes a midplane (not shown), a plurality of node cards 806a-b, a DMC 820a-b, a switch card (not shown), power supplies 805a-b, fans 804a-b, and a SCB 803a-b. Each of the DMCs 820a-b comprises a central processing unit (CPU) 829a-b to provide the on-board intelligence for the DMCs 820a-b. Each of the CPUs 829a-b is respectively connected to memories (not shown) containing a firmware and/or software that runs on the DMCs 820a-b, IPMB controller 821a-b, and other devices, such as a programmable logic device (PLD) 825a-b for interfacing the IPMB controller 821a-b with the CPU 829a-b. The SCB 803a-b provides the control and status of the system 800 such as monitoring healthy status of all the FRUs, powering ON and OFF the FRUs, etc. Each of the SCBs 803a-b is interfaced with at least one DMC 820a-b via at least one I2C 811a-b, 813a-b so that the DMC 820a-b can access and control the FRUs in the system 800. The fans 804a-b provide the cooling to the entire system 800. Each of the fans 804a-b has a fan board which provides control and status information about the fans and like the SCBs 803a-b are also controlled by at least one DMC 820a-b through at least one I2C 811a-b, 813a-b. The power supplies 805a-b provide the required power for the entire system 800. The DMC 820a-b manages the power supplies 805a-b through at least one I2C 811a-b, 813a-b (e.g., the DMC 820a-b determines the status of the power supplies 805a-b and can power the power supplies 805a-b ON and OFF). The nodes 806a-b are independent computing nodes and the DMC 820a and/or 820b manages these nodes though at least one IPMB 812a-b, 814a-b.

In addition, each of the IPMB controller 821a-b has its own CPU core and runs the IPMB protocol over the IPMBs 812a-b, 814a-b to perform the management of the computing nodes 806a-b. IPMB Controller 821a-b is also the central unit (or point) for the management of the system 800. The CPU 829a-b of the DMC 820a-b can control the IPMB controller 821a-b and get the status information about the system 800 by interfacing with the IPMB controller 821a-b via PLD 825a-b. The IPMB controller 821a-b respectively provides the DMC 820a-b with the IPMB 812a-b (the IPMBs then connects with the “intelligent FRUs,” such as node cards and switch fabric card) and the I2C 811a-b (the I2Cs then connectes with the “other FRUs,” such as fans, power supplies, and SCB).

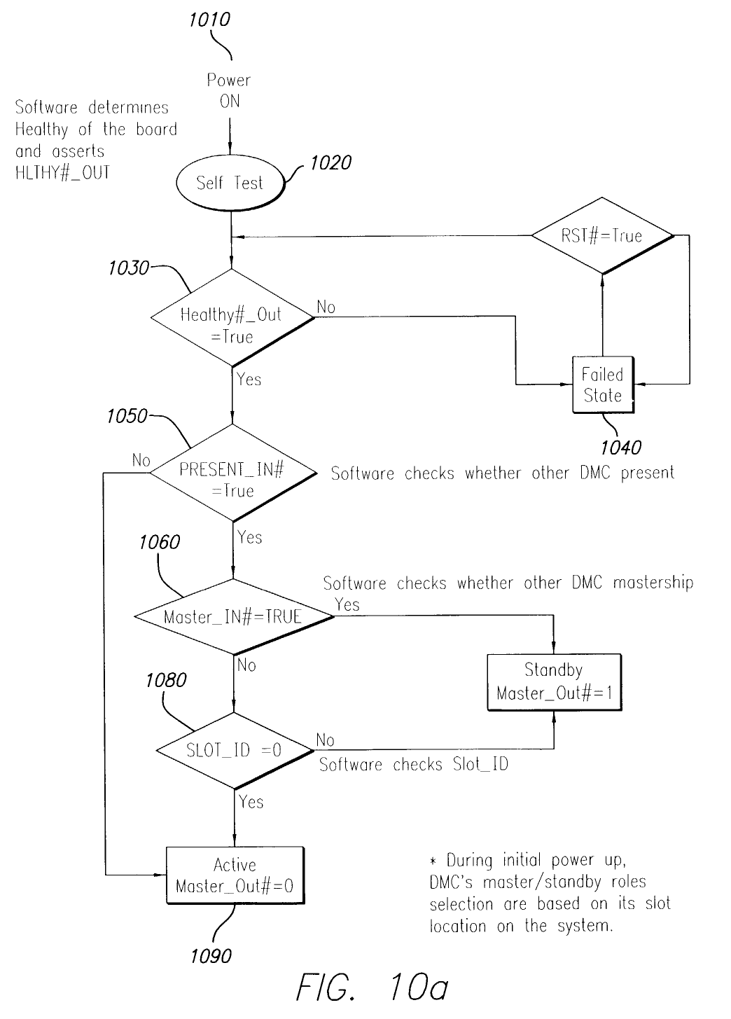

In the context of the present invention and referring now also to FIG. 9, a I2C can be categorized as a home I2C (PSM_I2C or I2C) or a remote I2C (REM_I2C). The PSM_I2C 811a-b respectively is the I2C which originates from its own DMC 820a-b. For example, PSM_I2C 811a originates from DMC 820a and is directly connected to power supplies 805a, fans 804a, and SCB 803a. The REM_I2C 813b from drawer 802 (the other or remote drawer) is connected with PSC_I2C 811a so that the DMC 820b of drawer 802 can access and manage the FRUs in 801 in case of a failure on DMC 820a The PSC_I2C 811b from DMC 820b has similar functions and interconnections as PSC_I2C 811a described above.

Like the I2C, an IPMB of the present invention can be categorized as a home IPMB (IPMB) or a remote IPMB (REM_IPMB). For example, the REM_IPMB 814a from drawer 801 is connected with IPMB 812b via IPMB controller 821b so that the DMC 820a of drawer 801 can manage all the computing nodes 806b on drawer 802 in case of a failure on DMC 820b. The REM_IPMB 814b from DMC 820b has similar functions and interconnections as REM_IPMB 814a.

Drawers 801, 802 also generate control (or handshake) signals 815a-b (e.g., a signal on the health of the DMC, a signal on which DMC is in a master state, a reset signal, a present signal, and/or a master override signal) to perform the redundant management among the two drawers. A serial peripheral Interface (SPI) 816 is used to perform the heartbeat between the two DMCs 820a-b (i.e., to perform the periodic checks of the active DMC to determine whether the active DMC is healthy or not). A serial management channel (SMC) 817 may also be used as a redundant heartbeat channel between the DMCs 820a-b in case of a failure on SPI 816. The features, objects, embodiments, functions, and/or mechanisms of the control signals 815a-b, SPI 816, and SMC 817 are described in greater detail below.

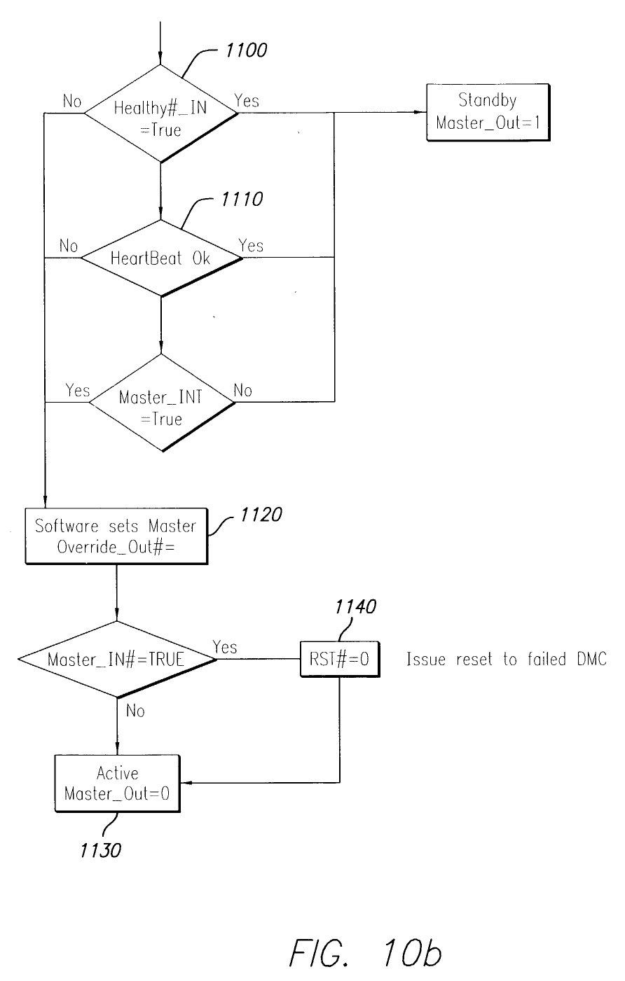

In general according to the foregoing, the invention provides an exemplary method for selecting a DMC that is to be in an active state and a DMC that is to be in a standby state, as diagrammed in FIGS. 10a-b. The numbers in the parentheses below refer to the steps taken to make the decision whether a DMC is to be in a master/standby and/or active/passive state.

Initially, at least one DMC is provided in each drawer. When the two (or more) drawers (or DMCS) are connected together using DBA, only one DMC will function as master (active) DMC and another DMC will function as a standby DMC. Referring now to FIG. 10a, the drawers (or DMCS) are powered ON at the same time (1010). A DMC then runs a self test at step 1020. If it passes the self test, a DMC software (running on the DMC) asserts a health signal (e.g., a HEALTHY#_OUT) to determine the health of the DMC (1030). If the signal indicates the DMC is not healthy, the DMC enters into a failed state (i.e., the HEALTHY#_OUT signal of one DMC will go as input to another DMC as HEALTHY#IN) (1040). If the DMC passes the health determination (i.e., it is healthy), the DMC then checks whether the other DMC is present in the system (or not) by probing a present signal (e.g., a PRESNT_IN# signal) which is coming from the other DMC (1050). If the other DMC is present, a selecting algorithm or software will be run to determine which DMC will be in a master state and which will be in a standby state (e.g., 1060, 1080). For example, when both the DMCs are present in the system, both the DMCs will check whether the other DMC is in master (active) role (or not) by checking, a master signal, such as a Master_IN# signal (1060). If none of the DMCs are in the master role, the DMCs check the slot identification (SLOT_ID) on each of the DMC (1080). The slot identifications (slot ids) are different for each drawer (or DMC), for example, if one drawer (or DMC) is zero, the other drawer (or DMC) will be one. The DMCs use this difference to decide their master/standby role. Referring also to FIG. 9, the slot ids 818a-b, respectively, may be hardwired and fixed by using a drawer bridge assembly 817a-b (having a pull-up resistor). The DMC which is suppose to be the master (e.g., having a SLOT_ID=0) will assert the Master OUT# bit and acquire the master role (1090). The other DMC will act in a standby role until the active DMC fails or when there is a user intervention. If only one DMC is present in the system, the DMC will take an active role immediately (1090).

Referring now to FIG. 10b, the standby DMC constantly checks the active DMC's health status (HEALTHY_IN#) (1100). The standby DMC may use SPI and/or SMC to perform the heartbeat check (1110). The standby DMC will initiate the take over role to become active if any one of the following conditions occurres:

1. the active DMC is not healthy (HEALTHY_IN# is not true);

2. a heartbeat failure occurs (checks using SPI and/or SMC interfaces); and/or

3. a user intervention occurs (a user can forcibly change the roles by asserting the front panel Master_INT# switch on the DMC).

As soon as the standby DMC finds any one of the above conditions, the standby DMC software asserts a master override bit, such as a Master_Override_Out# bit (1120). This signal will interrupt the current active DMC to relinquish the active role. (The Master_Override_out# will go as Master_Override_IN# to another DMC which will interrupt the other DMC's CPU). The current active DMC will then start the process of relinquishing its active role and as soon as it completes the relinquishing process it will deassert its master indication (the Master_LIN#) to indicate that it is no longer the master DMC. The standby DMC will then check the master indication (the Master_IN# signal) and as soon as the active DMC relinquished the active role, the standby DMC asserts its master indication (the Master_OUT#) and becomes the active or master DMC (1130).

In addition, a mechanism has been provided by the present invention to recover (e.g., restart, reboot, and/or reset) a DMC when that DMC is at a fault condition. Referring still to FIG. 10b, the DMCs have the capability to recover and/or reset (RST#) each other, for example, the standby DMC can reset the active DMC (1140). In one embodiment, the reset (RST#) signals are sent from one DMC to another DMC through a DBA.

Embodiments of the invention may be implemented by a computer firmware and/or computer software in the form of computer-readable program code executed in a general-purpose computing environment; in the form of bytecode class files executable within a platform-independent run-time environment running in such an environment; in the form of bytecodes running on a processor (or devices enabled to process bytecodes) existing in a distributed environment (e.g., one or more processors on a network); as microprogrammed bit-slice hardware; as digital signal processors; or as hard-wired control logic. In addition, the computer and circuit system described above are for purposes of example only. An embodiment of the invention may be implemented in any type of computer and circuit system or programming or processing environment.

Having thus described a preferred embodiment of a system and method for interconnecting nodes of a redundant computer system, it should be apparent to those skilled in the art that certain advantages of the within system have been achieved. It should also be appreciated that various modifications, adaptations, and alternative embodiments thereof may be made within the scope and spirit of the present invention. For example, a system using an electrical cable to connect two drawers of a redundant system has been illustrated, but it should be apparent that the inventive concepts described above would be equally applicable to systems that use other types of connectors, or that use one, three or more drawers. The invention is further defined by the following claims.

What is claimed is:

1. A compact peripheral component interconnect (compactPCI) computer architecture, comprising:
a plurality of compactPCI systems each comprising a plurality of nodes and a drawer management card (DMC), said DMC comprising a plurality of local communication links providing management interfaces for said plurality of nodes, said plurality of nodes comprising a first node providing a computational service, said plurality of nodes further comprising a second node comprising one of a fan node, a system control board node and a power supply node; and
a bridge assembly communicating with said plurality of compactPCI systems, said bridge assembly comprising a cable compatible with any one of said local communication links and connected with each of said compactPCI systems via said DMC for each of said compactPCI systems;
whereupon a failure of a first DMC for a first one of said compactPCI systems, a second DMC for a second one of said compactPCI systems assumes a management operation for said first DMC.

2. The compactPCI computer architecture of claim 1, wherein said local communication links comprise a first bus providing management interfaces for said first node and a second bus providing management interfaces for said second node.

3. The compactPCI computer architecture of claim 1, wherein said local communication links comprise an Intelligent Platform Management Bus and an Inter Integrated Circuit bus.

4. The compactPCI computer architecture of claim 1, wherein one DMC manages all of said nodes in all of said compactPCI systems.

5. The compactPCI computer architecture of claim 1, wherein said first DMC is configured to be an active DMC that actively manages all of said nodes in all of said compactPCI systems and wherein said second DMC is configured to be a standby DMC that periodically checks with said active DMC to determine whether said active DMC can still actively manage all of said nodes in all of said compactPCI system.

6. The compactPCI computer architecture of claim 1, wherein if said cable becomes inoperative, said compact PCI systems may still function in a non-redundant mode.

7. The compactPCI computer architecture of claim 1, wherein said second DMC for said second one of said compactPCI systems can reset said first DMC for said first one of said compactPCI systems.

8. The compactPCI computer architecture of claim 1, wherein said first DMC for said first one of said compactPCI systems comprises a first hardware to indicate that it is to be an active DMC.

9. The compactPCI computer architecture of claim 8, wherein said first hardware comprises a pull-up resistor.

10. The compactPCI computer architecture of claim 8, wherein said second DMC for said second one of said compactPCI systems comprises a second hardware to indicate that it is to be a standby DMC.

11. The compactPCI computer architecture of claim 10, wherein said second DMC comprises a software to indicate that it is to be an active DMC if said first DMC fails to manage all of said nodes in all of said compactPCI system.

12. The compactPCI computer architecture of claim 11, wherein said second DMC comprises a memory for storing said software and a central processing unit (CPU) for running said software.

13. The compactPCI computer architecture of claim 8, wherein said first hardware comprises a slot identification.

14. The compactPCI computer architecture of claim 1, wherein said cable comprises a first interface and a second interface, wherein said first and second DMCs communicate through said first interface, and wherein said first and second DMCs communicate through said second interface upon a failure of said first interface.

15. The compact PCI computer architecture of claim 14, wherein said first interface is a serial peripheral interface and wherein said second interface is a serial management channel.

16. A compact peripheral component interconnect (compactPCI) computer architecture, comprising:
a first compactPCI drawer system comprising a first plurality of nodes and a first drawer management card (DMC), said first DMC comprising a first plurality of communication links providing management interfaces for said first plurality of nodes;
a second compactPCI drawer system comprising a second plurality of nodes and a second DMC, said second DMC comprising a second plurality of communication links providing management interfaces for said second plurality of nodes;
a cable compatible with any one of said plurality of communication links and connected with said first and second DMCs;
wherein management operations provided from any one of said DMCs can manage said first and second plurality of nodes; and
wherein upon a failure of said first DMC, said second DMC assumes a management operation for said first DMC.

17. The compact PCI computer architecture of claim 16, wherein said first plurality of communication links are coupled to said second plurality of communication links through said cable.

18. The compact PCI computer architecture of claim 17, wherein said first compactPCI drawer comprises a first buffer, wherein said second compactPCI drawer comprises a second buffer, wherein said cable is connected with said first and second DMCs via said first and second buffers to compensate for loading limitations of said first and second plurality of communication links.

19. A method for redundantly managing a plurality of compact peripheral component interconnect (compactPCI) drawer systems, comprising the steps of:
providing a first drawer management card (DMC) to a first compactPCI drawer system;
providing a first plurality of nodes on said first compactPCI drawer system;
providing a second DMC to a second compactPCI drawer system;
providing a second plurality of nodes on said second compactPCI drawer system;
connecting said first DMC with said second DMC via a cable;
selecting said first DMC to be in an active state;
selecting said second DMC to be in a standby state;
using said first DMC to manage said first and second plurality of nodes;
checking periodically a condition on said first DMC;
switching said second DMC to be in an active state if said checked condition matches a predetermined condition; and
using only said second DMC to manage said first and second plurality of nodes.

20. The method of claim 19, wherein said predetermined condition comprises one of a condition wherein said first DMC is not healthy, a condition wherein a failure on a periodic check of said first DMC occurs, and a condition wherein a user forcibly intervenes.
